(19) United States
(12) Patent Application Publication
(10) Pub. No.: US 2025/0063559 A1
(43) Pub. Date: Feb. 20, 2025

(54) Radio Access Network Control System

(71) Applicant: Northeastern University, Boston, MA (US)

(72) Inventors: Salvatore D'ORO, Brookline, MA (US); Michele POLESE, Boston, MA (US); Leonardo BONATI, Boston, MA (US); Tommaso MELODIA, Newton, MA (US)

(21) Appl. No.: 18/720,864

(22) PCT Filed: Feb. 21, 2023
(86) PCT No.: PCT/US2023/013492

§ 371 Date: Jun. 17, 2024

Related U.S. Application Data
(60) Provisional application No. 63/311,552, filed on Feb. 18, 2022.

(51) Int. Cl. H04W 72/044; H04W 24/02

(52) U.S. Cl. CPC H04W 72/046; H04W 24/02

(57) ABSTRACT

Provided herein are methods and systems for radio access network (RAN) control including receiving, at a base station controller deployed at a base station of the RAN, a data input corresponding to a real-time operational status of the base station; determining a locally optimal signal configuration of the base station; controlling the base station to change a configuration of a signaling component to implement the locally optimal signal configuration; receiving, at an edge controller deployed at an edge of the RAN, a plurality of the locally optimal signal configurations corresponding to a plurality of the base stations within the RAN; determining a coordinated optimal signal configuration of each base station; and instructing, by the edge controller, the base station controller to change a configuration of the signaling component of the base station from the locally optimal signal configuration to the coordinated optimal signal configuration.

### CROSS REFERENCE TO RELATED APPLICATIONS

This application claims benefit under 35 U.S.C. § 119(e) of U.S. Provisional Application No. 63/311,552, filed on 18 Feb. 2022, entitled “SCALABLE CLOSED-LOOP CONTROL AND OPTIMIZATION OF RADIO ACCESS NETWORK (RAN) PARAMETERS WITH RAN INTELLIGENT CONTROLLERS,” the entirety of which is incorporated by reference herein.

### STATEMENT REGARDING FEDERALLY SPONSORED RESEARCH OR DEVELOPMENT

This invention was made with government support under Grant No. 1923789 awarded by the National Science Foundation and Grant No. N00014-20-1-2132 awarded by the Office of Naval Research. The government has certain rights in the invention.

### BACKGROUND

The fifth-generation (5G) of cellular networks and its evolution (NextG), will mark the end of the era of inflexible hardware-based Radio Access Network (RAN) architectures in favor of innovative and agile solutions built upon softwarization, openness and disaggregation principles. This paradigm shift—often referred to as Open RAN—comes with unprecedented flexibility. It makes it possible to split network functionalities—traditionally embedded and executed in monolithic base stations—and instantiate and control them across multiple nodes of the network. In this context, the O-RAN Alliance, a consortium led by Telecommunications Companies (Telcos), vendors and academic partners, is developing a standardized architecture for Open RAN that promotes horizontal disaggregation and standardization of RAN interfaces, thus enabling multi-vendor equipment interoperability and algorithmic network control and analytics. As shown in FIG. 1, O-RAN 100 embraces the 3rd Generation Partnership Project (3GPP) functional split of the RAN 103 with Central Units (CUs) 107, Distributed Units (DUs) 109, and Radio Units (RUs) 111 implementing different functions of the protocol stack. O-RAN also introduces (i) a set of open standardized interfaces to interact, control and collect data from every node of the network; as well as (ii) RAN Intelligent Controllers (RICs) that execute third-party applications over an abstract overlay to control RAN functionalities, i.e., xApps in the near-real-time (near-RT) RIC 105 and rApps in the non-real-time (non-RT) RIC 101. The O-RAN architecture makes it possible to bring automation and intelligence to the network through Machine Learning (ML) and Artificial Intelligence (AI), which will leverage the enormous amount of data generated by the RAN—and exposed through the O-RAN interfaces—to analyze the current network conditions, forecast future traffic profiles and demand, and implement closed-loop network control strategies to optimize the RAN performance. For this reason, how to design, train and deploy reliable and effective data-driven solutions has recently received increasing interest from academia and industry alike, with applications ranging from controlling RAN resource and transmission policies, to forecasting and classifying traffic and Key Performance Indicators (KPIs), thus highlighting how these approaches will be foundational to the Open RAN paradigm.

However, such disaggregation presents significant synchronization challenges, and although the 3GPP NR standard specifies ranges and possible values for various parameters, it does not define routines for placement of such signals and their corresponding parameters.

### SUMMARY

Provided herein are methods and systems for Radio Access Network (RAN) control. Such RAN control systems include one or more sets of closed-loop control routines that optimize multiple RAN operational parameters (e.g., beamforming, network slicing, load balancing, spectrum allocation, interference) based on a combination of controllers running in the RAN or at the edge of the network or in the cloud, and open interfaces that allow exposure of telemetry and analytics from the RAN, and the application of control actions or policies. Disclosed herein are also solutions to coordinate message passing between multiple data-driven entities controlling the network as well as human-centered and human-friendly data analytics and data visualization for enhanced monitoring and control experience.

Particular advantages of the described methods and systems for federated learning for automated selection of high band mmWave sectors are described below.

In one aspect a method for radio access network (RAN) control is provided. The method includes receiving, at a base station controller deployed at a base station of the RAN, at least one data input corresponding to a real-time operational status of the base station. The method also includes determining, by the base station controller from the at least one data input, a locally optimal signal configuration of the base station. The method also includes controlling the base station to change a configuration of at least one signaling component of the base station to implement the locally optimal signal configuration. The method also includes receiving, at an edge controller deployed at an edge of the RAN, a plurality of the locally optimal signal configurations corresponding to a plurality of the base stations within the RAN. The method also includes determining, by the edge controller from the plurality of the locally optimal signal configurations, a coordinated optimal signal configuration of each base station. The method also includes instructing, by the edge controller, the base station controller to change a configuration of the at least one signaling component of the base station from the locally optimal signal configuration to the coordinated optimal signal configuration.

In some embodiments, the method also includes detecting, from the at least one data input, at least one change to a deployment environment or user pattern corresponding to the base station. In some embodiments, the method also includes determining, upon detection of the at least one change, a revised locally optimal signal configuration of the base station. In some embodiments, the method also includes controlling the base station to change the configuration of the at least one signaling component of the base station to implement the revised locally optimal signal configuration. In some embodiments, the method also includes continuously or periodically repeating the steps of detecting the at least one change, determining the revised locally optimal signal configuration, and controlling the base station to implement the revised locally optimal signal configuration to form a real-time (RT) control loop. In some embodiments, the method also includes receiving, at the edge controller, at least one of the revised locally optimal signal configurations corresponding to at least one the base stations within the RAN. In some embodiments, the method also includes determining, by the edge controller from the at least one of the revised locally optimal signal configurations, a revised coordinated optimal signal configuration of each base station. In some embodiments, the method also includes instructing, by the edge controller, the base station controller to change the configuration of the at least one signaling component of the base station from the revised locally optimal signal configuration to the revised coordinated optimal signal configuration. In some embodiments, the method also includes continuously or periodically repeating the steps of receiving the at least one of the revised locally optimal signal configurations, determining a revised coordinated optimal signal configuration, and controlling the base station to implement a revised coordinated optimal signal configuration to form a near-real-time control loop.

In some embodiments, the method also includes assisting, by the base station controller, at least one user equipment (UE) connected to the corresponding base station to identify an optimal beam for use with a currently implemented signal configuration of the base station. In some embodiments, step of determining the locally optimal signal configuration and the step of determining the coordinated optimal signal configuration each include optimization of at least one of SS block placement, SRS placement, CSI-RS placement, or combinations thereof. In some embodiments, SS block placement is optimized by adjusting at least one of a number of SS blocks per burst, burst periodicity, mapping between SS blocks and codebook/directions, avoidance of pilot contamination via O-RAN-based coordination of multiple base stations, or combinations thereof. In some embodiments, CSI-RS placement is optimized by adjusting at least one of a number of CSI-RS to be monitored by each of a plurality of user equipment (UE), a direction of each of the CSI-RS to be monitored by each of the plurality of user equipment (UE), time allocations for the CSI-RS at the base station, frequency allocations for the CSI-RS at the base station, space allocations for the CSI-RS at the base station, or combinations thereof. In some embodiments, SRS placement is optimized by adjusting at least one of a number of SRS to be transmitted by each of a plurality of user equipment (UE), a direction of each of the SRS to be transmitted by each of the plurality of user equipment (UE), a periodicity of the SRS to be transmitted by each of the plurality of user equipment (UE), or combinations thereof.

In some embodiments, determination of the coordinated optimal signal configuration of each base station includes optimizing synchronization signal transmission to improve beam selection procedures and minimize intra-base station interference, pilot contamination and control overhead. In some embodiments, the at least one data input includes at least one of I/Q samples, telemetry, channel measurements and estimations, or combinations thereof corresponding to the base station. In some embodiments, the RAN is an O-RAN and the method also includes imposing, via at least one of an rApp executing at a non-real-time RIC of the RAN or xApps executing at a near-real-time RIC, one or more spectrum access and allocation policies configured to minimize interference between multiple base stations operating over same spectrum portions. In some embodiments the multiple base stations operating over the same spectrum portions belong to at least one of the same Radio Access Technology (RAT) or multiple RAT. In some embodiments, the RAT is selected from a group consisting of 5G, 6G, NR, WiFi, and LTE.

In some embodiments, the RAN is an O-RAN and the method also includes automating, via at least one of an rApp executing at a non-real-time RIC of the RAN or xApps executing at a near-real-time RIC, data exchange procedures over O-RAN interfaces between a plurality of distributed logic units of the RAN, including the base station controller and the edge controller. In some embodiments, the method also includes selecting, processing, and combining data to be exchanged according to the data exchange procedures to reduce overhead and to restrict transmitted data to exclude data irrelevant to the data-driven logic units. In some embodiments, the RAN is an O-RAN and the method also includes imposing, via at least one of an rApp executing at a non-real-time RIC of the RAN or xApps executing at a near-real-time RIC, power control policies for reducing inter-cell interference and power consumption. In some embodiments, the locally optimal signal configuration and the coordinated optimal signal configuration are reference and synchronization signal configurations.

In another aspect, a system for radio access network (RAN) control is provided. The system includes a plurality of base stations of the RAN. The system also includes a corresponding plurality of base station controllers deployed at the plurality of base stations. Each base station controller is configured to receive at least one data input corresponding to a real-time operational status of the base station. Each base station controller is configured to determine, from the at least one data input, a locally optimal signal configuration of the base station. Each base station controller is configured to control the base station to change a configuration of at least one signaling component of the base station to implement the locally optimal signal configuration. The system also includes at least one edge controller deployed at an edge of the RAN. Each edge controller is configured to receive a plurality of the locally optimal signal configurations corresponding to a plurality of the base stations within the RAN. Each edge controller is configured to determine, from the plurality of the locally optimal signal configurations, a coordinated optimal signal configuration of each base station. Each edge controller is configured to instruct the base station controller to change a configuration of the at least one signaling component of the base station from the locally optimal signal configuration to the coordinated optimal signal configuration.

Additional features and aspects of the technology include the following:
1. A method for radio access network (RAN) control comprising:
   receiving, at a base station controller deployed at a base station of the RAN, at least one data input corresponding to a real-time operational status of the base station;
   determining, by the base station controller from the at least one data input, a locally optimal signal configuration of the base station;
   controlling the base station to change a configuration of at least one signaling component of the base station to implement the locally optimal signal configuration;
   receiving, at an edge controller deployed at an edge of the RAN, a plurality of the locally optimal signal configurations corresponding to a plurality of the base stations within the RAN;
   determining, by the edge controller from the plurality of the locally optimal signal configurations, a coordinated optimal signal configuration of each base station; and
   instructing, by the edge controller, the base station controller to change a configuration of the at least one signaling component of the base station from the locally optimal signal configuration to the coordinated optimal signal configuration.
2. The method of feature 1, further comprising:
   detecting, from the at least one data input, at least one change to a deployment environment or user pattern corresponding to the base station;
   determining, upon detection of the at least one change, a revised locally optimal signal configuration of the base station;
   controlling the base station to change the configuration of the at least one signaling component of the base station to implement the revised locally optimal signal configuration.
3. The method of feature 2, further comprising continuously or periodically repeating the steps of detecting the at least one change, determining the revised locally optimal signal configuration, and controlling the base station to implement the revised locally optimal signal configuration to form a real-time (RT) control loop.
4. The method of any of features 2-3, further comprising:
   receiving, at the edge controller, at least one of the revised locally optimal signal configurations corresponding to at least one the base stations within the RAN;
   determining, by the edge controller from the at least one of the revised locally optimal signal configurations, a revised coordinated optimal signal configuration of each base station; and
   instructing, by the edge controller, the base station controller to change the configuration of the at least one signaling component of the base station from the revised locally optimal signal configuration to the revised coordinated optimal signal configuration.
5. The method of feature 4, further comprising continuously or periodically repeating the steps of receiving the at least one of the revised locally optimal signal configurations, determining a revised coordinated optimal signal configuration, and controlling the base station to implement a revised coordinated optimal signal configuration to form a near-real-time control loop.
6. The method of any of features 1-5, further comprising assisting, by the base station controller, at least one user equipment (UE) connected to the corresponding base station to identify an optimal beam for use with a currently implemented signal configuration of the base station.
7. The method of any of features 1-6, wherein the step of determining the locally optimal signal configuration and the step of determining the coordinated optimal signal configuration each include optimization of at least one of SS block placement, SRS placement, CSI-RS placement, or combinations thereof.
8. The method of feature 7, wherein SS block placement is optimized by adjusting at least one of a number of SS blocks per burst, burst periodicity, mapping between SS blocks and codebook/directions, avoidance of pilot contamination via O-RAN-based coordination of multiple base stations, or combinations thereof.
9. The method of any of features 7-8, wherein CSI-RS placement is optimized by adjusting at least one of a number of CSI-RS to be monitored by each of a plurality of user equipment (UE), a direction of each of the CSI-RS to be monitored by each of the plurality of user equipment (UE), time allocations for the CSI-RS at the base station, frequency allocations for the CSI-RS at the base station, space allocations for the CSI-RS at the base station, or combinations thereof.
10. The method of any of features 7-9, wherein SRS placement is optimized by adjusting at least one of a number of SRS to be transmitted by each of a plurality of user equipment (UE), a direction of each of the SRS to be transmitted by each of the plurality of user equipment (UE), a periodicity of the SRS to be transmitted by each of the plurality of user equipment (UE), or combinations thereof.
11. The method of any of features 1-10, wherein determination of the coordinated optimal signal configuration of each base station includes optimizing synchronization signal transmission to improve beam selection procedures and minimize intra-base station interference, pilot contamination and control overhead.
12. The method of any of features 1-11, wherein the at least one data input includes at least one of I/Q samples, telemetry, channel measurements and estimations, or combinations thereof corresponding to the base station.
13. The method of any of features 1-12, wherein the RAN is an O-RAN, the method further comprising imposing, via at least one of an rApp executing at a non-real-time RIC of the RAN or xApps executing at a near-real-time RIC, one or more spectrum access and allocation policies configured to minimize interference between multiple base stations operating over same spectrum portions.
14. The method of feature 13, wherein the multiple base stations operating over the same spectrum portions belong to at least one of the same Radio Access Technology (RAT) or multiple RAT.
15. The method of feature 14 wherein the RAT is selected from a group consisting of 5G, 6G, NR, WiFi, and LTE.
16. The method of any of features 1-15, wherein the RAN is an O-RAN, the method further comprising automating, via at least one of an rApp executing at a non-real-time RIC of the RAN or xApps executing at a near-real-time RIC, data exchange procedures over O-RAN interfaces between a plurality of distributed logic units of the RAN, including the base station controller and the edge controller.
17. The method of feature 16, further comprising selecting, processing, and combining data to be exchanged according to the data exchange procedures to reduce overhead and to restrict transmitted data to exclude data irrelevant to the data-driven logic units.
18. The method of any of features 1-17, wherein the RAN is an O-RAN, the method further comprising imposing, via at least one of an rApp executing at a non-real-time RIC of the RAN or xApps executing at a near-real-time RIC, power control policies for reducing inter-cell interference and power consumption.
19. The method of any of features 1-18, wherein the locally optimal signal configuration and the coordinated optimal signal configuration are reference and synchronization signal configurations.
20. A system for radio access network (RAN) control comprising:
   a plurality of base stations of the RAN;
   a corresponding plurality of base station controllers deployed at the plurality of base stations, each base station controller configured to:
      receive at least one data input corresponding to a real-time operational status of the base station;
      determine, from the at least one data input, a locally optimal signal configuration of the base station; and
      control the base station to change a configuration of at least one signaling component of the base station to implement the locally optimal signal configuration;
   at least one edge controller deployed at an edge of the RAN and configured to:
      receive a plurality of the locally optimal signal configurations corresponding to a plurality of the base stations within the RAN;
      determine, from the plurality of the locally optimal signal configurations, a coordinated optimal signal configuration of each base station; and
   instruct the base station controller to change a configuration of the at least one signaling component of the base station from the locally optimal signal configuration to the coordinated optimal signal configuration.

### BRIEF DESCRIPTION OF THE DRAWINGS

FIG. 1 illustrates an O-RAN reference architecture and interfaces in accordance with the prior art.

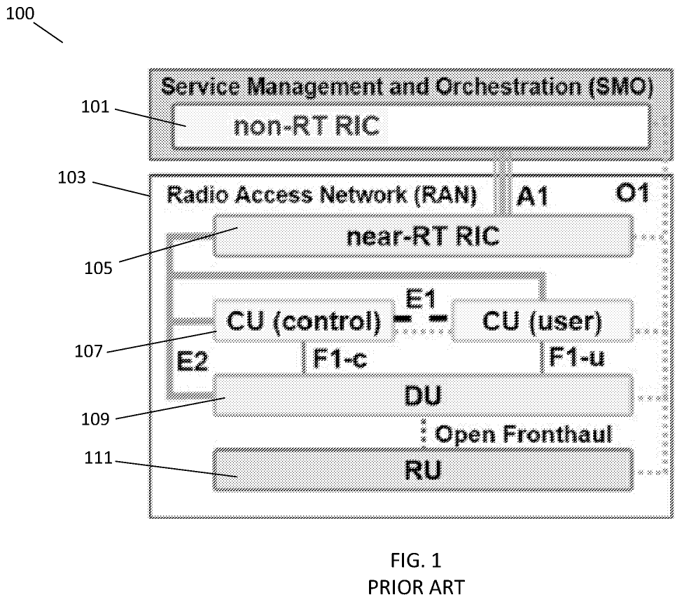

FIG. 2 illustrates a RAN control system in accordance with various embodiments.

FIG. 3 illustrates a phased control method implemented using a RAN control system in accordance with various embodiments.

### DESCRIPTION

Systems and methods for RAN control are described herein which are configured for maximizing spectral efficiency by optimizing the placement in time, frequency, and space of synchronization and reference signals for radio access networks. The optimal placement improves the accuracy of the channel estimation, especially when considering massive MIMO and mmWave deployments. Such systems also decrease overhead by selecting a minimum number of synchronization and reference signals to achieve channel estimation and throughput targets, and also decrease the latency required to complete control procedures. Such systems also reduce the pilot interference across multiple neighboring base stations thanks to smart placement of overlapping pilot signals in time and space.

### System Overview

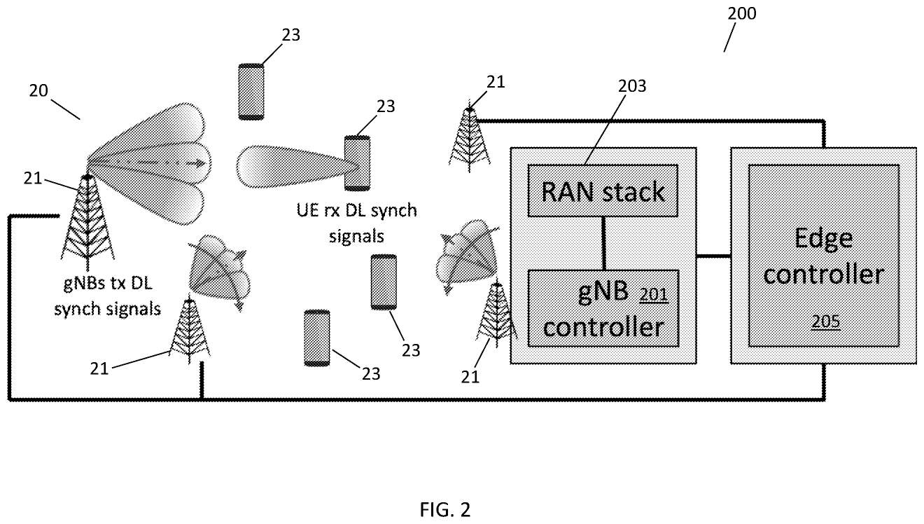

Referring now to FIG. 2, the RAN control systems 200 described herein generally operate within a network 20 having a plurality of base stations 21 (e.g., gNBs) configured for communication with one or more user equipment 23 (UE) devices. The base stations 21 can generally be configured for transmitting reference and synchronization signals with the goal of enabling the user equipment 23 (UE) to identify the best parameters (e.g., beam pair) for data exchange with the base station(s) 21. Each base station 21 is equipped with antenna panels, which can be used to transmit directional signals and/or for MIMO and spatial multiplexing. Each base station 21 also includes a protocol stack that implements the functionalities of the Radio Access Network (RAN) by controlling operational parameters of the base station 21 and elements thereof (e.g., antenna panels and transmitters) in accordance therewith.

Such functionalities can generally be determined and controlled via a set of closed-loop control routines that optimize multiple Radio Access Network (RAN) operational parameters, based on a combination of controllers running in the RAN or at the edge of the network or in the cloud, and open interfaces that allow exposure of telemetry and analytics from the RAN, and the application of control actions or policies.

### Base Station Controller

Each base station 21 of the RAN control system 100 is equipped with a real-time base station controller 201 configured to interface with the RAN stack 203 through Application Programming Interfaces (APIs). The base station controller 201 can perform real-time control of the parameters of the protocol stack and inference on I/Q samples and other data and control plane entities (e.g., packets, transport blocks, etc.). Specifically, the base station controller 201 processes received waveforms and locally available KPIs/KPMs and RF signals (in the form of I/Q samples) to control and optimize the parameters discussed above. Data is also enriched by actions taken by an edge controller 205.

For instance, in one example embodiment the base station controller 201 can include a software container hosting an AI solution (e.g., a Deep Reinforcement Learning (DRL) agent) that receives I/Q samples, KPMs/KPIs, packets, and enrichment information from an edge controller 205 (e.g., an O-RAN near-real-time RAN Intelligent Controller (near-real-time RIC)) to control beamforming patterns. More generally, the base station controller 201 uses AI to control reference and synchronization signal scheduling and configurations at each individual base station 21.

### Edge Controller

The RAN control system 200 can also include an edge controller 205 deployed at the edge of the network 10 for extending RAN capabilities. This edge controller 205 can interfaced with the base stations 21 and/or with one or more subsystems that compose a base station 21, in case of a disaggregated RAN. The edge controller 205 is configured to gather data from multiple base stations 21 and uses artificial intelligence (AI) and machine learning (ML), hereinafter referred to collectively as “AI” for convenience, to coordinate their reference and synchronization signal transmission, thereby improving beam selection procedures as well as minimizing intra-base station interference, pilot contamination, and control overhead. The data used by the edge controller 205 includes KPIs/KPMs as well as local decisions taken by each base station controller 201. In one example embodiment the edge controller 205 can be an xApp executing at the near-real-time RIC that embeds the intelligence (e.g., a DRL agent) and collects data from the different base stations 21 via an E2 interface of a RAN network.

By establishing such an interface between the edge controller 205 and the RAN nodes (e.g., base stations 21), the RAN control system 200 makes it possible to expose telemetry, statistics, notifications, and events from the RAN, and to implement policy and control from the edge controller 205 to the RAN. The data used by the edge controller 205 can include KPIs/KPMs as well as local decisions taken by each base-station-specific controller 201. In some embodiments, the edge controller 205 can include an xApp executing at the near-real-time RIC that embeds the intelligence (e.g., a DRL agent) and collects data from the different gNBs via the O-RAN E2 interface.

As described in greater detail below, the base station controller 201 and the edge controller 205 can interact to perform coordinated control of the RAN in a phased, hierarchical manner. The base station controller 201 hosted at the base station 21 is able to control reference signal transmissions of the individual base station 21 only, while the edge controller 205 takes decisions that operate at a higher level and affect one or more base stations at the same time.

### Multi-Domain Optimization of 3GPP NR Reference and Synchronization Signals Scheduling

The standard specifications for 3GPP NR include several synchronization and reference signals to estimate the channel between base stations and users and enable directional and massive MIMO communications. The standard specifies the signal structure, and possible values for parameters. These signals are the SS blocks, SRSs, and CSI-RSs. SS blocks are used for idle-mode or neighbor synchronization and channel estimation. Each SS block is associated to a specific beamforming vector in a codebook or to an angular (azimuth, elevation) direction. They are grouped in SS bursts, which contain at most L<=64 SS blocks in 5 ms. The SS bursts are repeated with a certain periodicity T. SRSs are connected-mode uplink reference signals that a UE can transmit on specific beamforming vectors or directions. CSI-RSs are connected-mode downlink reference signals that a gNB can map to specific UEs, beamforming vectors, or directions. The standard specifies ranges and possible values for the parameters, but it does not define routines for the optimization of the placement of these signals, and of their parameters.

RAN control systems 200 provided herein, in some embodiments, can be configured to maximize spectral efficiency by optimizing the placement in time, frequency, and space of synchronization and reference signals for radio access networks 20 The optimal placement improves the accuracy of the channel estimation, especially when considering massive MIMO and mmWave deployments. It also decreases the overhead, thanks to the selection of the minimum number of synchronization and reference signals to achieve channel estimation and throughput targets. It reduces the pilot interference across multiple neighboring base stations thanks to smart placement of overlapping pilot signals in time and space.

### Phased Control

In some embodiments, the RAN control system 200 can achieve network optimization via phased control methodologies configured to optimize each of three parameters.

Optimization of the placement of SS blocks. The RAN control system 200 can optimize SS block placement by adjusting a number of SS blocks per burst, burst periodicity, and/or mapping between SS blocks and codebook/directions, as well as considering O-RAN-based coordination among multiple base stations to avoid pilot contamination when appropriate.

Optimization of CSI-RS placement. The RAN control system 200 can optimize CSI-RS placement by controlling a number of CSI-RSs each UE needs to monitor, in which directions, as well as the CSI-RS's time, frequency, and space allocations at the gNB side.

Optimization of SRS placement. The RAN control system 200 can optimize SRS placement by controlling a number of SRSs each UE needs to transmit, in which directions, and with which periodicity.

As noted above, this phased control can be executed by a combination of two or more controllers, at least one base station controller 201 running in a base station 21 and at least one edge controller 205 running at the edge of the network 20.

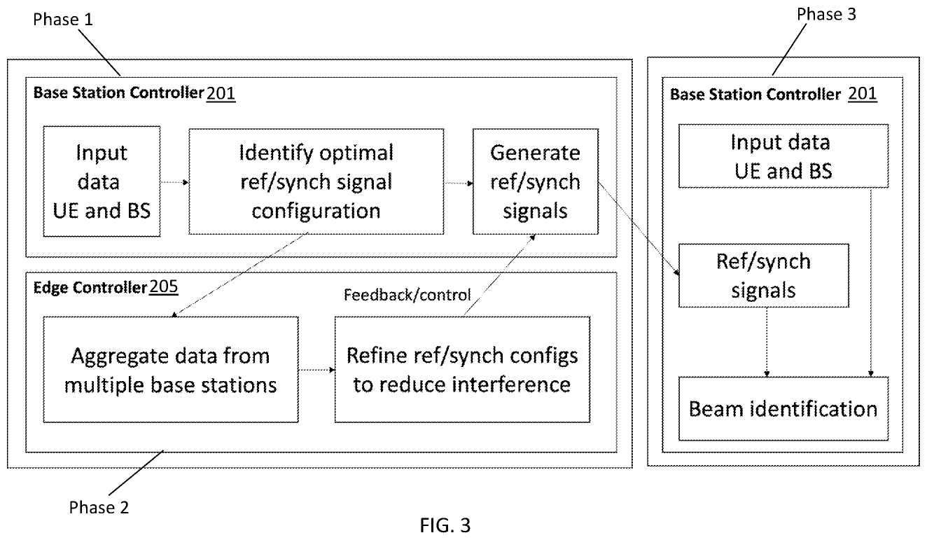

Referring now to FIG. 3, the RAN control system 200 can generally execute the phased control by managing interaction of the base station controller 201 running in the base station 21 and the edge controller 205 running at the edge (e.g., an O-RAN near-real-time RIC). The action space related to the control optimization of synchronization and reference signals can be split across the base station controller 201 and the edge controller 205 according to the availability of each of the controllers 201, 205, the latency constraints related to the decision being taken, and the availability of input data necessary to evaluate the action in either controller 201, 205. For example, in one example embodiment the RAN control system 200 could orchestrate the direction and periodicity of SS blocks/bursts at the edge, and CSI-RS and SRS at the base station 21.

In phase 1 the base-station-specific controller 201 identifies the best configuration of the reference and synchronization signal parameters for the base station 21 it controls. This can be done by using AI and, in general, data-driven optimization, to process several inputs from the base station stack (including I/Q samples, telemetry, channel measurements and estimations, etc.) and identify what is the best reference and synchronization signal configuration to be applied. This configuration is immediately applied, allowing the implementation of a real-time control loop. The procedure can be repeated whenever a change in the deployment environment or user pattern is detected, to properly tailor the configuration to the updated scenario.

In phase 2 the edge controller 205 receives the output of the decision from the local, real-time base station controller 201 and aggregates decisions and configurations from different base stations. The edge controller 205 then uses data-driven techniques to coordinate reference and synchronization signal transmission to improve beam selection procedures, and minimize intra-gNB interference, pilot contamination and control overhead.

In phase 3, the edge controller 205 can then instruct one or more of the base stations, via the corresponding base station controller 201, to change at least one operational configuration to improve coordination across the network.

The above operations can be implemented through a closed-loop control where actions taken by the two classes of controllers (i.e., the base station controller 201 and the edge controller 205) are updated continuously to adapt to current network state, channel and traffic conditions.

The phased control can then be extended to a fourth phase (not shown), where the local base station controller 201 also performs beam management itself. That is, the base station controller 201 can assist user equipment 23 connected to the base station 21 in identifying the best beam to be used.

Advantageously, the optimization operations in phases 1, 2, and 4 (if applicable) can be performed together. For example, if deep learning is used in steps 1 and 2 at the controller, then it is also possible to jointly train both the neural network that identifies the configuration of the reference synchronization signals and the neural network for beam management in a joint training process.

### Data-Driven Coordination, Data Visualization and Control of Open RAN Networks

In some embodiments, the RAN control system can be realized and/or enhanced by deploying a set of intelligent applications (e.g., rApps executing at the non-real-time RIC or xApps executing at the near-real-time RIC). Via such intelligent applications, the RAN control system can execute a data-driven approach that leverages O-RAN interfaces to collect data, generate control policies, and enforce them. The intelligent applications can leverage machine learning for performing the following tasks in conjunction with the RAN control system.

### Coordinating Multi-Cell and Multi-Radio Access Technology (Multi-RAT) Spectrum Management for Interference Mitigation and Enhanced Spectral Efficiency.

By collecting and combining data from one or more base stations, the intelligent applications (e.g., xApps and/or rApps) are provided with sufficient data to compute and suggest optimal spectrum access and allocation policies that minimize interference between multiple base stations operating over the same spectrum portions and belonging either to the same Radio Access Technology (RAT) or multiple RATs (e.g., 5G NR, WiFi, LTE). Accordingly, the intelligent applications are capable of providing and imposing spectrum access policies that minimize interference and improve spectral efficiency via agile spectrum reallocation. In some embodiments, rApps can be configured to compute an optimal set of spectrum access policies and then distribute those policies to other network components (e.g., base stations and base station controllers) via A1 interfaces.

### Scalable and Dynamic Message Passing for Distributed Data-Driven RAN Control.

By facilitating and improving the exchange of information between multiple data-driven logic units (e.g., multiple Deep Reinforcement Learning (DRL) agents) that control the RAN functionalities and parameters, the intelligent applications can maximize network performance. Being distributed, the multiple data-driven logic units might otherwise be unable to exchange information with one another. Moreover, without deployment of the intelligent applications, information exchange might result in high overhead if the amount of transmitted data is large, which can cause congestion and high latency over the control channel. Instead, the intelligent applications (i) automate data exchange procedures over O-RAN interfaces between multiple distributed data-driven logic units; and (ii) select, process, and combine the data to be exchanged so as to reduce overhead and transmit only data that is relevant to the data-driven logic units. These activities further support online fine-tuning of the intelligent applications to continuously update the way data is combined and processed according to changing network conditions and operator goals.

### Energy-Efficient Power Control and Coverage Adaptation.

By facilitating the collection of data from neighboring cells the intelligent applications can use such data to compute power control strategies for reducing inter-cell interference and power consumption while guaranteeing high-performance services to users at the edge of the cells and ensuring proper coverage.

### Human-Centered and Explainable Data Analytics and Visualization.

By embedding intelligent applications that offer augmented and context-aware data analytics to operators, the RAN control system can provide data visualization capabilities that are human-centered and understandable. This includes the capability to identify inefficiencies, suggest and characterize possible causes, and offer a human-understandable visualization platform that facilitates and eases the interpretation of the data.

### Example Features

Optimization of transmission parameters via data-driven optimization.
Possibility to move control logic at different locations of the network without impacting network performance.
Human-centered performance monitoring and network control.
Optimized message passing to reduce overhead and increase control efficacy.
Data-driven spectrum coexistence and spectrum management via data-driven spectrum sensing.

### Example Advantages

Better Quality of Experience (QoE) for users in terms of data rate, latency, and lower Operational Expenditure (OPEX) for operators.
Higher performance support new 5G/6G services that can be monetized by operators and service providers.
Human-centered data analytics and visualization facilitate network control and monitoring via policy suggestion and inefficiency/fault identification.
Possibility to operate a cellular network over unlicensed spectrum bands (i.e., no need to buy spectrum portion for billions of dollars).
Automates network management and control while delivering higher performance services. This results in lower Total Cost of Ownership (TCO) and new revenue streams thanks to the delivery of demanding 5G/6G services that are enabled by our technology
Data-driven optimization makes it possible to adapt network parameters and functionality to every small change in the network conditions, thus implementing control policies that are tailored to the current conditions of the network, thereby always delivering the highest performance possible.

### Example Industrial Applications

Private 5G/6G deployments.
High-performance 5G/6G networks via data-driven control and adaptation.
Smart warehouses (with robots, Unmanned Aerial Vehicles (UAVs), humans, Internet of Things (IoT)).
Coexistence between 5G/6G and WiFi.
Cellular Vehicle-to-Everything (C-V2X) for 5G/6G-based entertainment and self-driving cars.
Private 5G for smart warehouses, arenas, theaters, stadiums, industrial plants.
Secondary applications include Radio Unit (RU) and Distributed Unit (DU) design.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

What is claimed is:

1. A method for radio access network (RAN) control comprising:
receiving, at a base station controller deployed at a base station of the RAN, at least one data input corresponding to a real-time operational status of the base station;
determining, by the base station controller from the at least one data input, a locally optimal signal configuration of the base station;
controlling the base station to change a configuration of at least one signaling component of the base station to implement the locally optimal signal configuration;
receiving, at an edge controller deployed at an edge of the RAN, a plurality of the locally optimal signal configurations corresponding to a plurality of the base stations within the RAN;
determining, by the edge controller from the plurality of the locally optimal signal configurations, a coordinated optimal signal configuration of each base station; and
instructing, by the edge controller, the base station controller to change a configuration of the at least one signaling component of the base station from the locally optimal signal configuration to the coordinated optimal signal configuration.

2. The method of claim 1, further comprising:
detecting, from the at least one data input, at least one change to a deployment environment or user pattern corresponding to the base station;
determining, upon detection of the at least one change, a revised locally optimal signal configuration of the base station;
controlling the base station to change the configuration of the at least one signaling component of the base station to implement the revised locally optimal signal configuration.

3. The method of claim 2, further comprising continuously or periodically repeating the steps of detecting the at least one change, determining the revised locally optimal signal configuration, and controlling the base station to implement the revised locally optimal signal configuration to form a real-time (RT) control loop.

4. The method of claim 2, further comprising:
receiving, at the edge controller, at least one of the revised locally optimal signal configurations corresponding to at least one the base stations within the RAN;
determining, by the edge controller from the at least one of the revised locally optimal signal configurations, a revised coordinated optimal signal configuration of each base station; and
instructing, by the edge controller, the base station controller to change the configuration of the at least one signaling component of the base station from the revised locally optimal signal configuration to the revised coordinated optimal signal configuration.

5. The method of claim 4, further comprising continuously or periodically repeating the steps of receiving the at least one of the revised locally optimal signal configurations, determining a revised coordinated optimal signal configuration, and controlling the base station to implement a revised coordinated optimal signal configuration to form a near-real-time control loop.

6. The method of claim 1, further comprising assisting, by the base station controller, at least one user equipment (UE) connected to the corresponding base station to identify an optimal beam for use with a currently implemented signal configuration of the base station.

7. The method of claim 1, wherein the step of determining the locally optimal signal configuration and the step of determining the coordinated optimal signal configuration each include optimization of at least one of SS block placement, SRS placement, CSI-RS placement, or combinations thereof.

8. The method of claim 7, wherein SS block placement is optimized by adjusting at least one of a number of SS blocks per burst, burst periodicity, mapping between SS blocks and codebook/directions, avoidance of pilot contamination via O-RAN-based coordination of multiple base stations, or combinations thereof.

9. The method of claim 7, wherein CSI-RS placement is optimized by adjusting at least one of a number of CSI-RS to be monitored by each of a plurality of user equipment (UE), a direction of each of the CSI-RS to be monitored by each of the plurality of user equipment (UE), time allocations for the CSI-RS at the base station, frequency allocations for the CSI-RS at the base station, space allocations for the CSI-RS at the base station, or combinations thereof.

10. The method of claim 7, wherein SRS placement is optimized by adjusting at least one of a number of SRS to be transmitted by each of a plurality of user equipment (UE), a direction of each of the SRS to be transmitted by each of the plurality of user equipment (UE), a periodicity of the SRS to be transmitted by each of the plurality of user equipment (UE), or combinations thereof.

11. The method of claim 1, wherein determination of the coordinated optimal signal configuration of each base station includes optimizing synchronization signal transmission to improve beam selection procedures and minimize intra-base station interference, pilot contamination and control overhead.

12. The method of claim 1, wherein the at least one data input includes at least one of I/Q samples, telemetry, channel measurements and estimations, or combinations thereof corresponding to the base station.

13. The method of claim 1, wherein the RAN is an O-RAN, the method further comprising imposing, via at least one of an rApp executing at a non-real-time RIC of the RAN or xApps executing at a near-real-time RIC, one or more spectrum access and allocation policies configured to minimize interference between multiple base stations operating over same spectrum portions.

14. The method of claim 13, wherein the multiple base stations operating over the same spectrum portions belong to at least one of the same Radio Access Technology (RAT) or multiple RAT.

15. The method of claim 14 wherein the RAT is selected from a group consisting of 5G, 6G, NR, WiFi, and LTE.

16. The method of claim 1, wherein the RAN is an O-RAN, the method further comprising automating, via at least one of an rApp executing at a non-real-time RIC of the RAN or xApps executing at a near-real-time RIC, data exchange procedures over O-RAN interfaces between a plurality of distributed logic units of the RAN, including the base station controller and the edge controller.

17. The method of claim 16, further comprising selecting, processing, and combining data to be exchanged according to the data exchange procedures to reduce overhead and to restrict transmitted data to exclude data irrelevant to the data-driven logic units.

18. The method of claim 1, wherein the RAN is an O-RAN, the method further comprising imposing, via at least one of an rApp executing at a non-real-time RIC of the RAN or xApps executing at a near-real-time RIC, power control policies for reducing inter-cell interference and power consumption.

19. The method of claim 1, wherein the locally optimal signal configuration and the coordinated optimal signal configuration are reference and synchronization signal configurations.

20. A system for radio access network (RAN) control comprising:
a plurality of base stations of the RAN;
a corresponding plurality of base station controllers deployed at the plurality of base stations, each base station controller configured to:
receive at least one data input corresponding to a real-time operational status of the base station;
determine, from the at least one data input, a locally optimal signal configuration of the base station; and
control the base station to change a configuration of at least one signaling component of the base station to implement the locally optimal signal configuration;
at least one edge controller deployed at an edge of the RAN and configured to:
receive a plurality of the locally optimal signal configurations corresponding to a plurality of the base stations within the RAN;
determine, from the plurality of the locally optimal signal configurations, a coordinated optimal signal configuration of each base station; and
instruct the base station controller to change a configuration of the at least one signaling component of the base station from the locally optimal signal configuration to the coordinated optimal signal configuration.
